(19) United States
(12) Patent Application Publication
(10) Pub. No.: US 2026/0020530 A1
(43) Pub. Date: Jan. 22, 2026

(54) TOOLESS CONCAVE FASTENER

(71) Applicant: Deere & Company, Moline, IL (US)

(72) Inventors: Sheila E. Moroney, Davenport, IA (US); Daniel M. Heim, Port Byron, IL (US); Manish Singh, Bokaro (IN); Jeffrey R. Walter, Bettendorf, IA (US)

(21) Appl. No.: 18/777,749

(22) Filed: Jul. 19, 2024

(51) Int. Cl. A01F 12/26; A01F 12/28

(52) U.S. Cl. CPC A01F 12/26; A01F 12/28

(57) ABSTRACT

A latch assembly includes a carriage bolt including a threaded shaft having an enlarged head at one end with a non-circular shoulder adjacent the enlarged head. Each latch assembly further includes a thrust washer received about the carriage bolt, a nut threadedly received on the threaded shaft, and a cam lever pivotally attached to the nut. The cam lever pivots about a pivot axis perpendicular to a length of the threaded shaft, the cam lever including a cam surface configured to engage the thrust washer, the cam lever being pivotable from an unlatched position to a latched position such that engagement of the cam surface with the thrust washer during pivotal motion of the cam lever biases the thrust washer toward the enlarged head to thereby latch a mounting flange of a concave grate to a support flange of a support frame.

### BACKGROUND

### Field of the Disclosure

The present disclosure relates to systems for mounting a concave of a combine harvester.

### Background of the Disclosure

Agricultural harvesters, or combines, are large machines that harvest, thresh, separate and clean an agricultural crop. The resulting clean grain is stored in a grain tank located on the combine. The clean grain can then be transported from the grain tank to a truck, grain cart or other receiving bin by an unloading auger. There are three basic types of combines: (1) a conventional combine having a transverse threshing cylinder for threshing the harvested crop, and straw walkers for separating the threshed crop; (2) a hybrid combine having a transverse threshing cylinder for threshing the harvested crop, and one or more separator rotors within a housing for separating the threshed crop; and (3) a rotary combine having a rotor within a housing for threshing and separating the harvested crop.

In conventional and hybrid combines, the crop processing unit comprises a transverse threshing cylinder mounted in close proximity to a grate called a concave. The rotating threshing cylinder in conjunction with the fixed concave threshes the crop material. The concave generally comprises a series of transversely extending bars through which are inserted axially running wires. A concave of this type forms a grate through which the majority of the threshed grain and chaff fall onto a collecting assembly where it is directed to the cleaning system of the combine. U.S. Pat. Nos. 4,909,772 and 5,024,631 each disclose a conventional transverse concave for a conventional combine. In hybrid combines with rotary separation, the crop processing unit additionally comprises one or more rotors surrounded by a housing. The bottom of the housing is provided with a series of separating grates through which the grain and chaff fall from the housing.

Rotary combines are provided with an infeed section for pulling crop material into the rotary crop processing unit from the feederhouse, a threshing section for threshing the crop material, and a separating section for separating the grain from the threshed crop material. The rotary crop processing unit comprises a rotor that is surrounded by a housing. The bottom of the housing is provided with a series of grates through which the grain and chaff fall from the housing. The grates located beneath the threshing section of the rotary crop processing unit comprises a concave, such a concave is disclosed in U.S. Pat. No. 4,499,908. In this patent one side of the concave is pivotally mounted to the crop processing unit and the other side is adjustably mounted to the crop processing unit to control the clearance between the concave and rotor. U.S. Pat. Nos. 5,613,907 and 6,193,604 each disclose a concave for a rotary combine.

Crop material, especially green crop material and high volume crop material, tends to plug the concave, not allowing grain to pass through the concave and thus reducing capacity and threshing ability. Often, removal of the concave is required in order to clear the plugged material. Furthermore, in some rotary combines, it is necessary to change between two different concaves, with different sized openings, when changing between harvesting of small and large grain crops. Thus, it is desirable that mounting means for the concave provide for ease of attachment and removal.

### SUMMARY

The present disclosure provides systems for mounting concave grates in the support frame of a combine harvester.

In a first embodiment an agricultural harvester machine includes a thresher including a thresher rotor received within a thresher housing, the thresher housing including a support frame and a plurality of concave grates mounted on the support frame. The support frame includes a support flange, the support flange having a plurality of support flange apertures defined therethrough. Each concave grate includes a mounting flange having at least one mounting flange aperture defined therethrough, the mounting flange aperture being aligned with one of the support flange apertures when the concave grate is mounted on the support frame. One or more latch assemblies connect each of the concave grates to the support frame. Each of the latch assemblies includes a carriage bolt including a threaded shaft having an enlarged head at one end with a non-circular shoulder adjacent the enlarged head, the shaft being dimensioned to be received through the aligned mounting flange aperture and support flange aperture with the non-circular shoulder closely received in one of the apertures to prevent rotation of the carriage bolt. Each latch assembly further includes a thrust washer received about the carriage bolt, a nut threadedly received on the threaded shaft, and a cam lever pivotally attached to the nut. The cam lever pivots about a pivot axis perpendicular to a length of the threaded shaft, the cam lever including a cam surface configured to engage the thrust washer, the cam lever being pivotable from an unlatched position to a latched position such that engagement of the cam surface with the thrust washer during pivotal motion of the cam lever biases the thrust washer toward the enlarged head to thereby latch the mounting flange of the concave grate to the support flange of the support frame.

In another embodiment a method of mounting a concave grate on a support frame of a thresher housing of an agricultural harvester machine includes: engaging the concave grate with the support frame; aligning a mounting flange aperture of the concave grate with a support frame aperture of the support frame; providing a carriage bolt and cam lever assembly including a carriage bolt, a thrust washer received about the carriage bolt, a nut threadedly engaged with the carriage bolt, and a cam lever pivotally mounted on the nut; inserting an enlarged head of the carriage bolt through the aligned mounting flange aperture and support frame aperture; moving a shaft of the carriage bolt laterally into a slot of one of the apertures, the slot having a width greater than a diameter of the shaft and smaller than a minimum dimension of the enlarged head perpendicular to a length of the shaft, so that the support frame and the mounting flange are received between the enlarged head and the thrust washer; engaging a non-circular shoulder of the carriage bolt with the slot with the enlarged head engaging either the support frame or the mounting flange; adjusting a threaded connection between the nut and the carriage bolt; and pivoting the cam lever relative to the nut from an unlatched position to a latched position such that engagement of the cam surface with the thrust washer during pivotal motion of the cam lever biases the thrust washer toward the enlarged head to thereby latch the mounting flange of the concave grate to the support frame.

Numerous objects, features and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a semi-schematic side elevation view of a self propelled agricultural harvester having a rotary crop processing assembly.

FIG. 2 is a semi-schematic perspective view of the rotary crop processing assembly.

FIG. 3 is a perspective view of a support frame or cradle.

FIG. 4 is a perspective view of a concave grate.

FIG. 5 is a another perspective view of the concave grate.

FIG. 6 is an axial end view of the support frame with an inner concave grate and an outer concave grate mounted therein.

FIG. 7 is an enlarged view of a central portion of FIG. 6 showing the latch assembly and the mounting flange in partial cross-section.

FIG. 8 is an enlarged bottom view showing one of the latch assemblies of FIG. 6 and the associated mounting and support flanges.

FIG. 9 is an enlarged bottom view showing both of the latch assemblies of FIG. 6 and the associated mounting and support flanges. Here the latch assemblies are shown in partial cross-section.

FIG. 10 is an exploded view of one of the latch assemblies.

FIG. 11 is a plan view of one of the keyhole shaped mounting apertures for receiving one of the latch assemblies.

FIG. 12 is a side elevation view of the cam lever of one of the latch assemblies.

### DETAILED DESCRIPTION

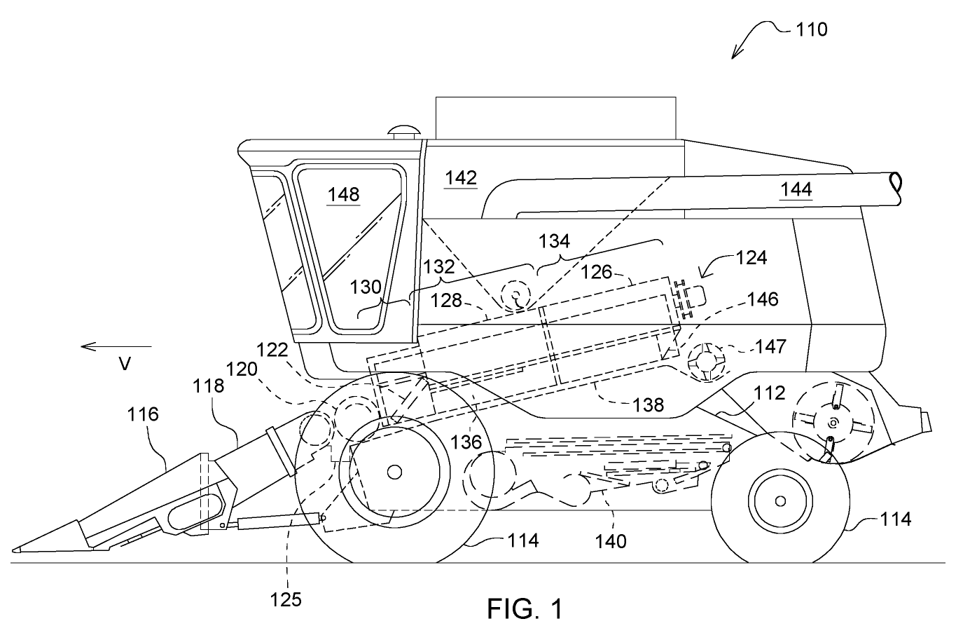

FIG. 1 shows an agricultural harvester machine 110, or combine, comprising a supporting structure or frame 112 having ground engaging wheels 114. A harvesting platform 116 is used for harvesting a crop and directing it to a feederhouse 118. The harvested crop is directed by the feederhouse 118 to a beater 120. The beater directs the crop upwardly through the inlet transition section 122 to a rotary crop processing unit or thresher 124. A rock trap 125 is positioned between the feederhouse and the beater 120.

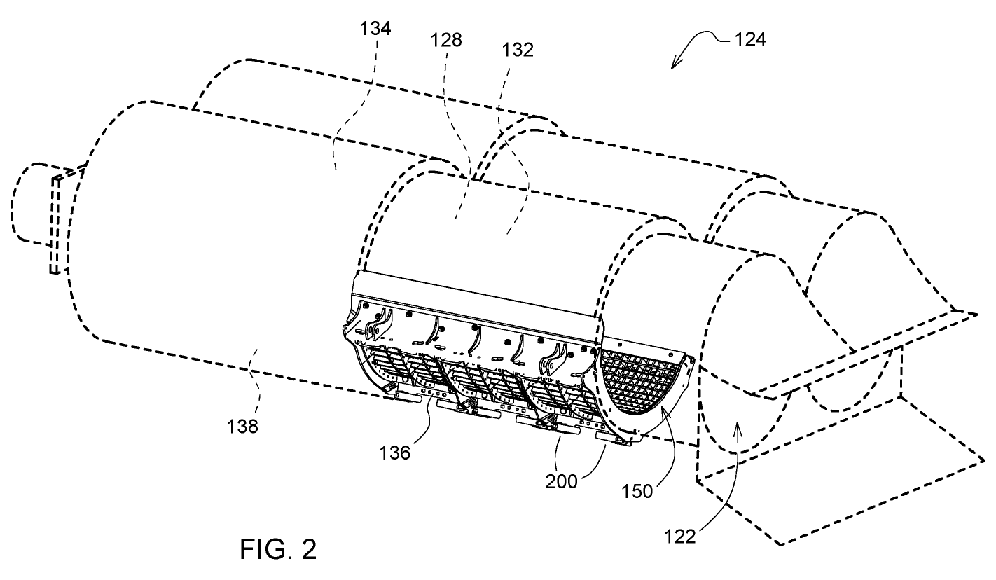

FIG. 1 shows the rotary crop processing unit 124, which threshes and separates the harvested crop material. The rotary crop processing unit 124 comprises rotating crop processing member, or thresher rotor 126, circumferentially surrounded by a thresher housing 128 that together define an inlet section 130, a threshing section 132 and a separating section 134. The rotor 126 comprises a hollow cylindrical drum having a plurality of crop processing elements that engage the crop and rotate it in the housing 128. As best seen in FIG. 2, the bottom of the housing has a grate, known as a concave 136, under the threshing section 132, and a separating grate 138 under the separating section 134.

Grain and chaff falling through the concave 136 and the separating grate 138 are directed to cleaning system 140. The cleaning system 140 removes the chaff and directs the clean grain to a clean grain elevator (not shown). The clean grain elevator deposits the clean grain in a grain tank 142. The clean grain in the tank 142 can be unloaded into a grain cart or truck by an unloading auger 144. Threshed and separated straw is discharged from the rotary crop processing unit 124 through outlet 146 to a discharge beater 147. The discharge beater in turn propels the straw out the rear of the combine. The operation of the combine is controlled from operator's cab 148.

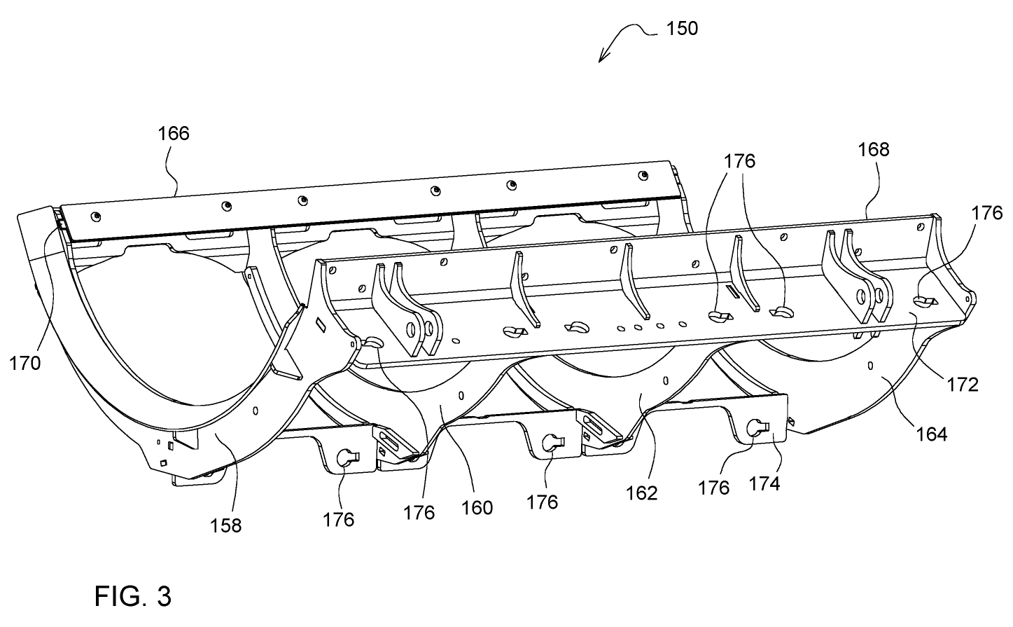

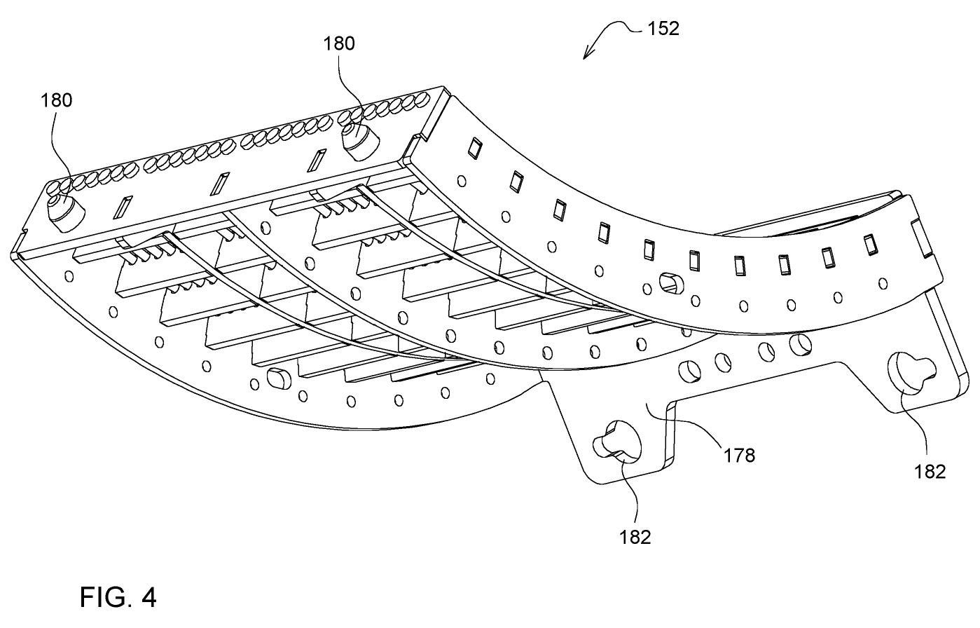

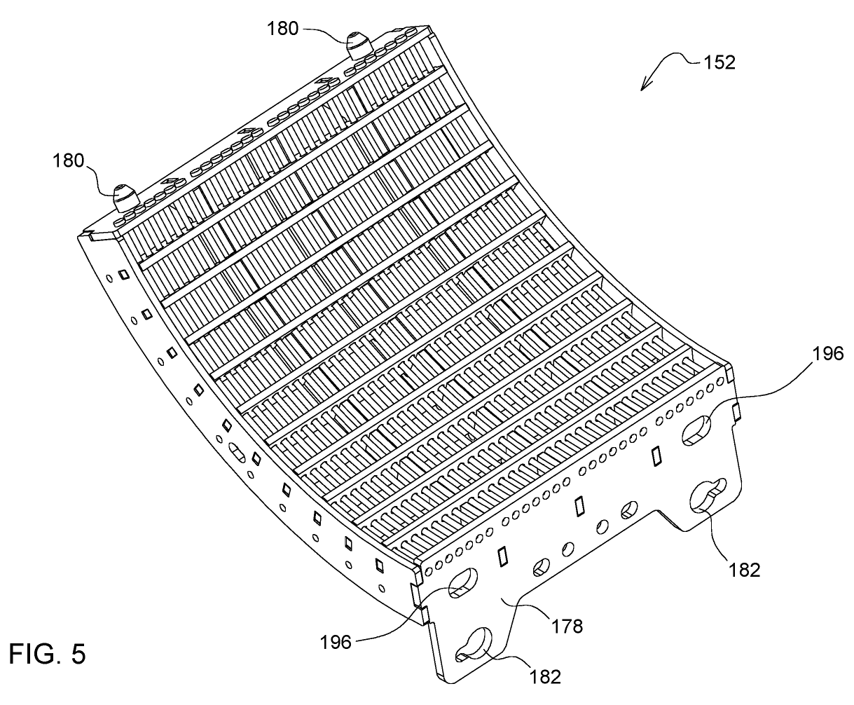

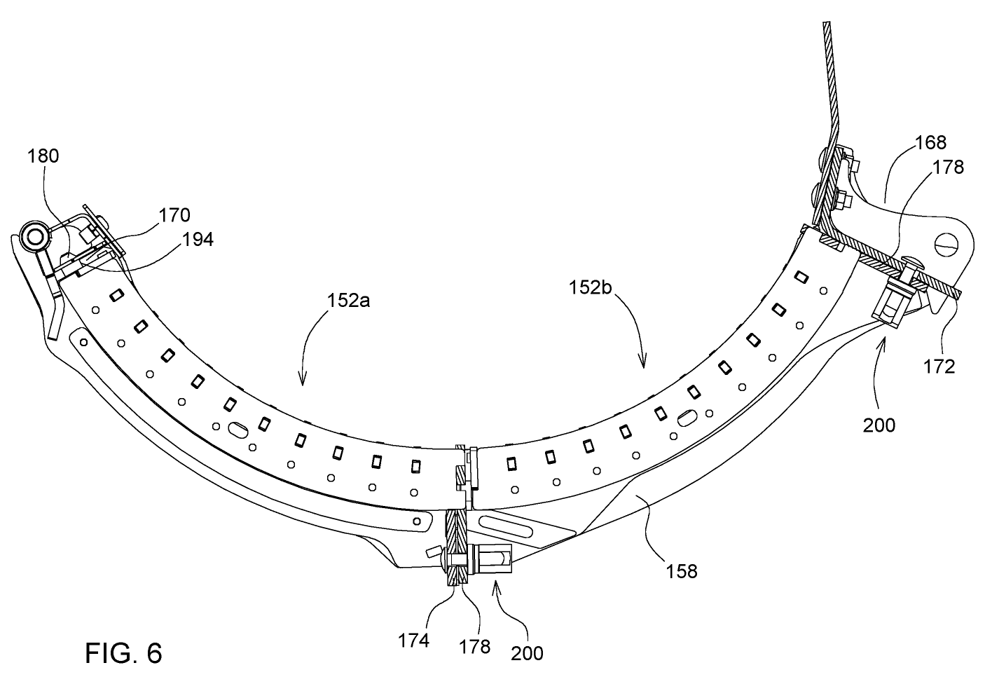

The thresher housing 128 includes a support frame 150 such as seen in FIG. 3. The support frame 150 may also be referred to as a cradle 150 or cradle frame 150. The concave 136 includes a plurality of concave grates 152 such as seen in FIGS. 4 and 5. . As can be appreciated from FIGS. 3 and 6 the support frame 150 may hold six of the concave grates 152 to make up the concave 136.

The details of the support frame 150 are seen in FIG. 3. The support frame 150 includes four arcuate ribs 158, 160, 162 and 164 joined together by an inner longitudinal support 166 and an outer longitudinal support 168. The inner longitudinal support 166 includes an inner support flange 170. The outer longitudinal support 168 includes an outer support flange 172. A middle support flange 174 also joins the ribs 158-164. Each of the support flanges 172 and 174 includes a plurality of support flange apertures 176 defined therethrough.

As seen in FIGS. 4 and 5, each of the concave grates 152 is arcuate in shape complementary to the size and shape of the support frame 150. As can be seen in FIG. 6, an inner concave grate 152a will be mounted between the inner support flange 170 and the middle support flange 174, and an outer concave grate 152b will be mounted between the middle support flange 174 and the outer support flange 172.

Each of the concave grates 152 includes a mounting flange 178 on one circumferential end thereof and a pair of locating pins 180 extending from the other circumferential end thereof. The locating pins 180 may also be referred to as mounting protuberances 180. The mounting flange 178 may extend radially outward relative to the arcuate shape of the concave grate 152 as shown, but in other embodiments the mounting flange may be non-radially oriented. The mounting flange 178 includes a plurality of mounting flange apertures 182 defined therethrough.

FIG. 11 shows the detailed shape of one of the mounting flange apertures 182. The support flange apertures 176 may be identical in shape and dimension. The mounting flange apertures 182 may be keyhole shaped including a circular end portion 184 and a radial slot portion 186. The circular end portion 184 may have a diameter 188. The radial slot portion 186 may extend radially relative to a center 190 of the circular end portion 184. The radial slot portion has a width 192. The keyhole shape may also vary from that shown; it may have a non-circular end portion and a longer or differently shaped slot portion.

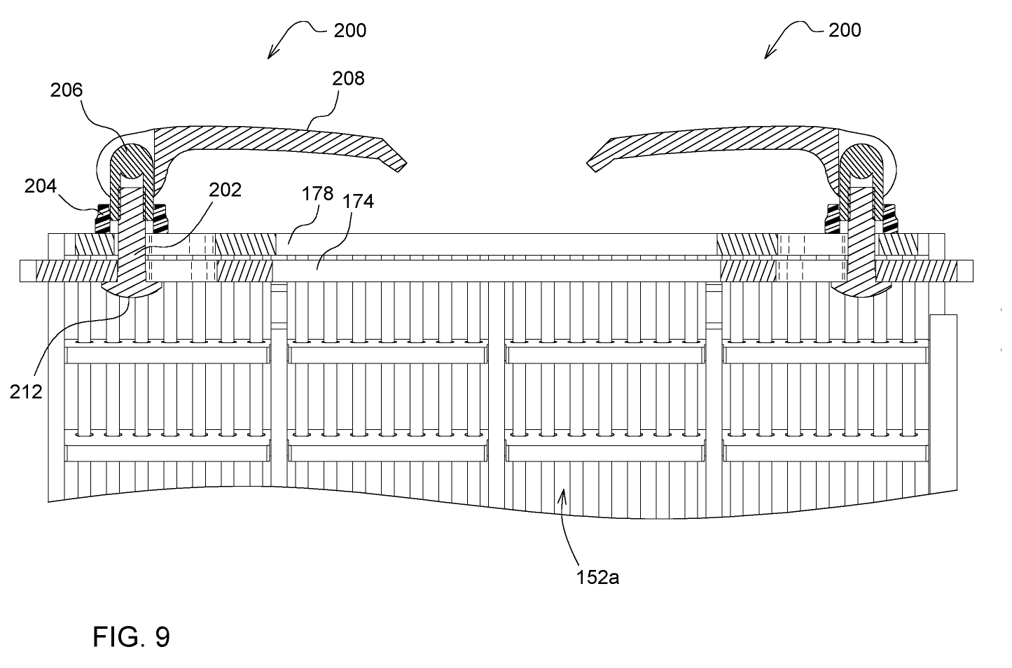

As best seen in FIG. 6, to mount the inner concave grate 152a in the support frame 150 the locating pins 180 of the inner concave grate 152a are inserted into pin receiving openings 194 in the inner support flange 170 and the mounting flange 178 of inner concave grate 152a is placed against the middle support flange 174 with the mounting flange apertures 182 of the mounting flange 178 overlying and aligned with the support flange apertures 176 of the middle support flange 174. Two latch assemblies 200 are used to connect the inner concave grate 152a to the middle support flange 174 of the support frame 150 as seen in FIG. 9.

Then the outer concave grate 152b is mounted by inserting its locating pins 180 through pin receiving slots 196 in the mounting flange 178 of the inner concave grate 152a and then placing the mounting flange 178 of the outer concave grate 152b against the outer support flange 172 of support frame 150 as seen in FIG. 6. Then two further latch assemblies 200 may be used to connect the outer concave grate 152b to the outer support flange 172 of support frame 150.

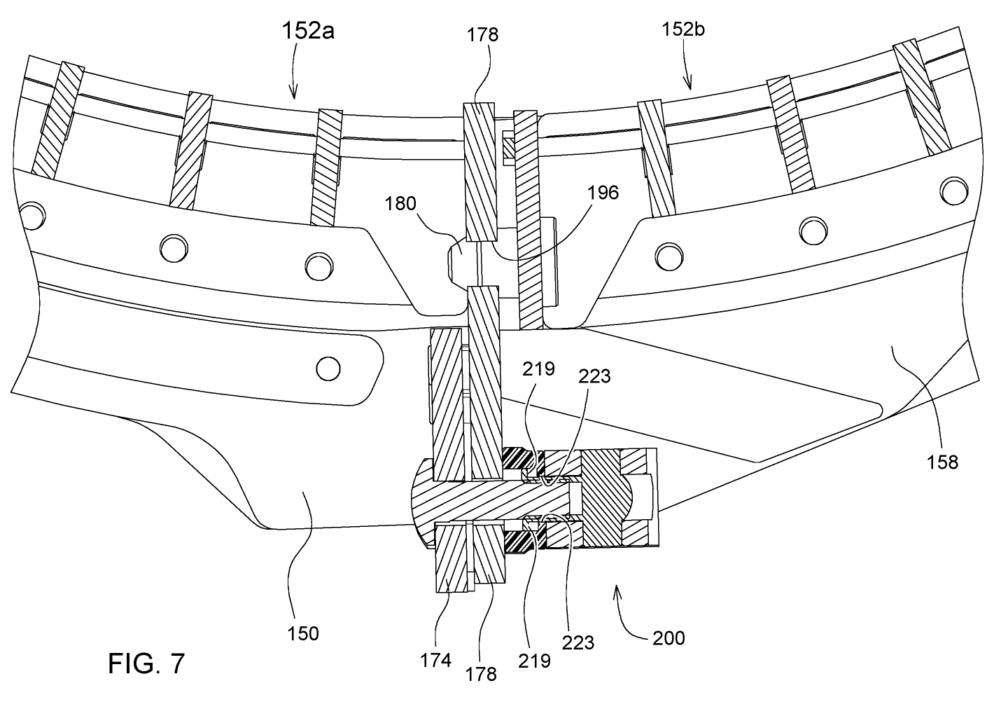

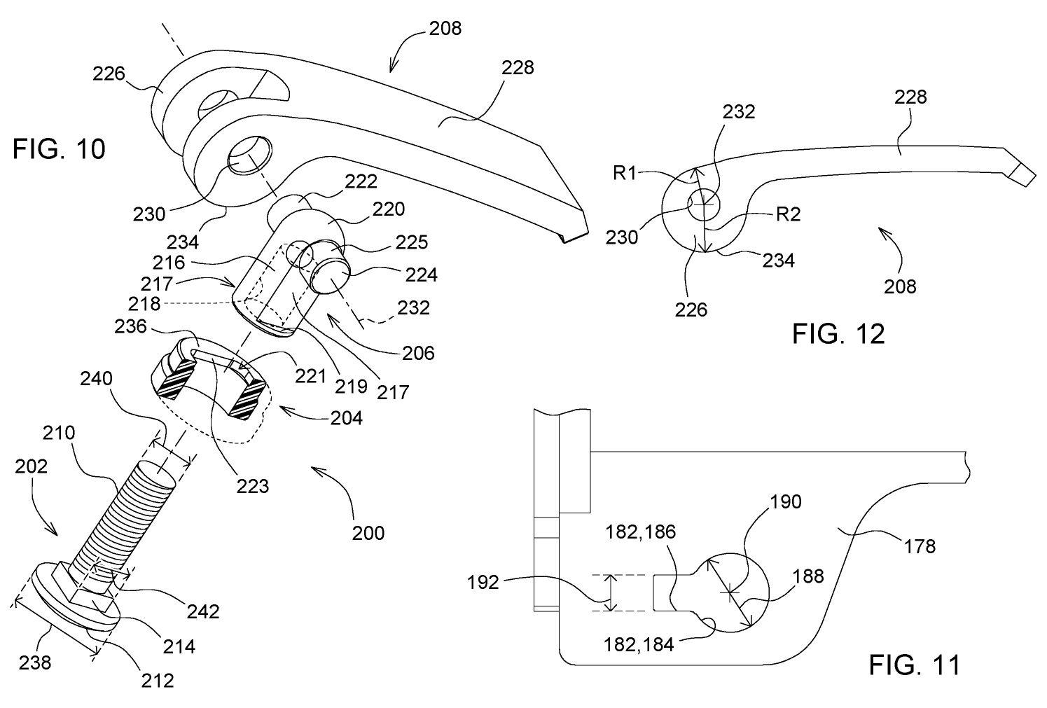

FIG. 10 is an exploded view of one of the latch assemblies 200. Latch assembly 200 includes a carriage bolt 202, a thrust washer 204, a nut 206 and a cam lever 208. The details of the cam lever 208 are further shown in FIG. 12. The carriage bolt 202 includes a threaded shaft 210 having an enlarged head 212 at one end with a non-circular shoulder 214 adjacent the enlarged head 212. When assembled as seen for example in FIGS. 7-9, the thrust washer 204 is received about the threaded shaft and the nut 206 is threadedly engaged with the free end of the threaded shaft 210.

The nut 206 may be a T-nut 206 including a stem 216 having a threaded interior bore 218 for threadedly engaging the threaded shaft 210. The T-nut 206 may include a cross-head 220 adjoining the cylindrical stem 216 and having first and second pin shaped ends 222 and 224. The cam lever 208 includes an eccentric cam head 226 and a handle 228 extending from the cam head 226. Cam head 226 has a bore 230 which receives the pin shaped ends 222 and 224 so that the cam lever 208 is pivotally mounted on the T-nut 206 to pivot about a pivot axis 232. Pivot axis 232 is perpendicular to the length of the threaded shaft 210. It will be appreciated that the pin shaped ends 222 and 224 may be defined on a separable pin portion 225 of the cross head 220 to permit assembly of the cam lever 208 with the nut 206.

As best seen in FIGS. 7 and 10, the stem 216 of T-nut 206 may be partially cylindrical in cross-section with two diametrically opposed flats 217 formed along most of its length leaving two shallow lips 219 at the lower end of stem 216. The washer 204 may have a central opening 221 through which the middle part of the stem 216 along the flats 217 is received. The opening 221 may be shaped complementary to a cross-section of the stem 216 at the flats 217, but slightly larger in dimension, so that the washer 204 may slide along the stem 216. As best seen in FIG. 7, the washer 204 has an inwardly protruding lip 223 adjacent opening 221 and overlapping the lips 219 of stem 216 so that the washer 204 may be assembled with the T-nut 206 in a manner that prevents the washer 204 from falling off the end of stem 216.

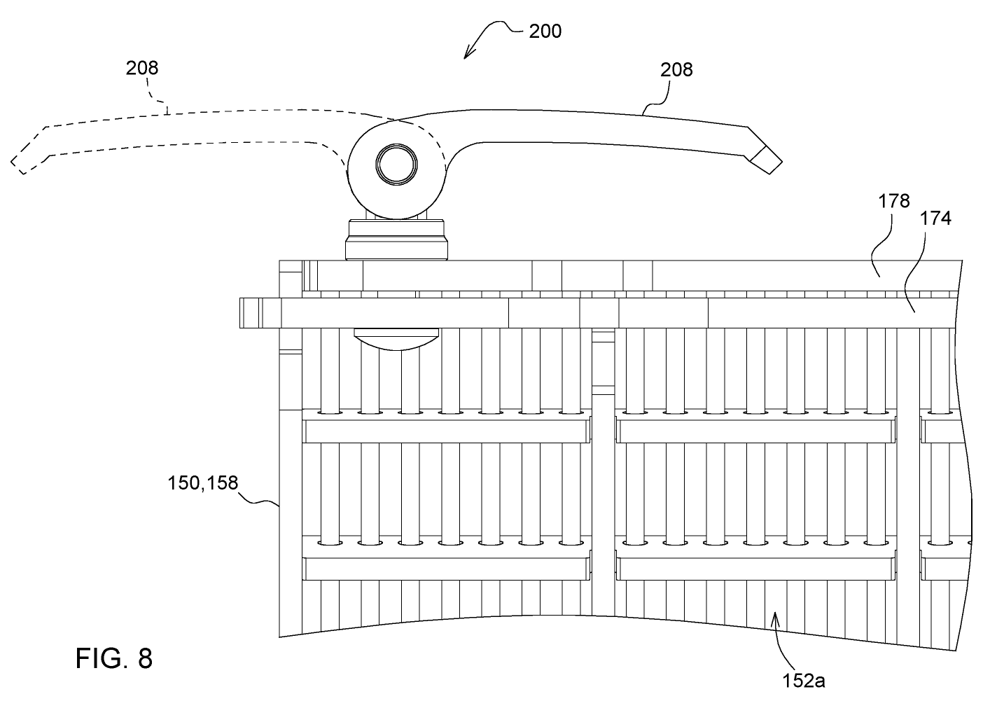

As best shown in FIG. 12, the eccentric cam head 226 has a camming surface 234 defined thereon which may have an increasing radius relative to axis 232, increasing from a smaller radius R1 to a larger radius R2. When the latch assembly 200 is assembled as seen in FIGS. 7-9 the cam surface 234 engages a top surface 236 of washer 204. When the cam lever 208 is pivoted from an unlatched position as shown in dashed lines in FIG. 8 to a latched position as shown in solid lines in FIG. 8, engagement of the cam surface 234 with the thrust washer 204 biases the thrust washer 204 towards the enlarged head 212.

The enlarged head 212 of the carriage bolt 202 may be circular having a diameter 238. Diameter 238 may also be referred to as a maximum width of the enlarged head 212, and it will be appreciated that the head 212 may have a shape other than a circular shape. The threaded shaft 210 may have a shaft diameter 240. The shoulder 214 may have a minimum cross-sectional dimension 242, which in the case of a square shoulder 214 will be the width of a side of the square shoulder.

The dimensions of the latch assembly 200 are chosen relative to the dimensions of the support flange apertures 176 and the mounting flange apertures 182. They are chosen such that the enlarged head 212 may be inserted through the circular end portions 184 of the apertures 176 and 182 and then moved laterally so that the non-circular shoulder 214 is closely received in the radial slot portions 186. The width 192 of the radial slot portions 186 is only slightly greater than the minimum cross-sectional dimension 242 of shoulder 214 so that rotation of the carriage bolt 202 within the apertures 176 and 182 is prevented.

The circular end portion 184 of each aperture 182 has a diameter 188 larger than the maximum width 238 of the enlarged head 212 so that the enlarged head 212 may fit through the circular end portion 184. The radial slot portion 186 has its width 192 greater than the shaft diameter 240 and less than the maximum width 238 of the enlarged head 212. The width 192 of the radial slot portion 186 is greater than the minimum cross-section 242 of the non-circular shoulder 214, but is small enough that the non-circular shoulder 214 may be held within the slot 186 to prevent rotation of the carriage bolt 202.

The non-circular shoulder 214 may be square in cross-section normal to the length of the threaded shaft 210 so that a position of the carriage bolt 202 within the aligned apertures 176 and 182 may be adjusted by integral increments of 90 degrees.

As seen in FIGS. 4 and 5 each of the mounting flanges 178 includes two of the mounting flange apertures 182 which align with two corresponding support flange apertures 176 so that two latch assemblies 200 may connect each of the concave grates 152a or 152b to the support frame 150 as seen in FIG. 9. The mounting flange apertures 182 and thus the received latch assemblies 200 are spaced apart longitudinally relative to the arcuate shape of the concave grates.

The construction of the latch assemblies 200 permits the concave grates 152 to be assembled with the support frame 150 in a tooless manner. The concave grates 152 may be serviced or exchanged easily in the field by hand without the use of any tools.

A method of mounting one of the concave grates 152 on the support frame 150 of the thresher housing 128 may be described as including: engaging the concave grate 152 with the support frame 150; aligning the mounting flange aperture 182 of the concave grate 152 with one of the support frame apertures 176 of the support frame 150; providing the carriage bolt and latch assembly 200 including the carriage bolt 202, the thrust washer 204 received about the carriage bolt, the nut 206 threadedly engaged with the carriage bolt, and the cam lever 208 pivotally mounted on the nut; inserting the enlarged head 212 of the carriage bolt 202 through the aligned mounting flange aperture 182 and the support frame aperture 176; moving the shaft 210 of the carriage bolt 202 laterally into the slot 186 of one of the apertures 176, 182, the slot having the width 192 greater than the diameter 240 of the shaft 210 and smaller than the minimum dimension 238 of the enlarged head 212 perpendicular to a length of the shaft 210, so that the support frame 150 and the mounting flange 178 are received between the enlarged head 212 and the thrust washer 204 as seen for example in FIG. 7; engaging the non-circular shoulder 214 of the carriage bolt with the slot 186 with the enlarged head 212 engaging either the support flange 172, 174 of the support frame 150 or the mounting flange 178; adjusting the threaded connection between the nut 206 and the carriage bolt 202; and pivoting the cam lever 208 relative to the nut 206 from the unlatched position to the latched position such that engagement of the cam surface 234 with the thrust washer 204 during pivotal motion of the cam lever 208 biases the thrust washer 204 toward the enlarged head 212 to thereby latch the mounting flange 178 of the concave grate 152 to the support frame 150.

During the aligning of the apertures the circular end portions 184 and the slots 186 of the apertures 176 and 182 are aligned.

During the adjusting of the threaded connection between the nut 206 and the carriage bolt 202 with the cam lever in the unlatched position the nut 206 may be tightened until the cam surface 234 engages the surface 236 of the thrust washer 204 with the support flange 172 or 174 of the support frame 150 and the mounting flange 178 snugly received between the enlarged head 212 and the thrust washer 204. Then pivoting of the cam lever 208 relative to the nut 206 from the unlatched position to the latched position tightly sandwiches the support flange 172 or 174 of the support frame 150 and the mounting flange 178 between the enlarged head 212 and the thrust washer 204. It will be appreciated that the thrust washer 204 is free to slide axially relative to the carriage bolt 202 and the nut 206 during the latching process.

In one embodiment as illustrated in FIG. 9 the pivoting of the cam lever 208 to the latched position may result in the cam lever 208 being aligned with a length of the thresher housing 128. It will be appreciated that to receive a desired final alignment of the cam lever 208, while achieving a suitably tight clamping of the concave grate 152 to the support frame 150, it may be necessary to adjust the rotational position of the carriage bolt 202 within the slot 186. When using a square shoulder 214 such rotational position adjustment may be made in an integral multiple of 90 degrees by removing the square shoulder 214 from the slot 186, rotating the carriage bolt 210 the desired integral multiple of 90 degrees relative to the nut 206 and then reinserting the square shoulder 214 in the slot 186.

To replace the concave grates 152 of the support frame 150 when equipped with the latch assemblies 200, the operator can manually unlatch the latches 200 and remove the concave grates. Then a new set of concave grates can be inserted as described above and manually latched in place using the latch assemblies 200.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. An agricultural harvester machine, comprising:
a thresher including a thresher rotor received within a thresher housing, the thresher housing including a support frame and a plurality of concave grates mounted on the support frame:
the support frame including a support flange, the support flange having a plurality of support flange apertures defined therethrough;
each concave grate including a mounting flange having at least one mounting flange aperture defined therethrough, the mounting flange aperture being aligned with one of the support flange apertures when the concave grate is mounted on the support frame; and
one or more latch assemblies connecting each of the concave grates to the support frame, each of the latch assemblies including:
a carriage bolt including a threaded shaft having an enlarged head at one end with a non-circular shoulder adjacent the enlarged head, the shaft being dimensioned to be received through the aligned mounting flange aperture and support flange aperture with the non-circular shoulder closely received in one of the apertures to prevent rotation of the carriage bolt;
a thrust washer received about the carriage bolt;
a nut threadedly received on the threaded shaft; and
a cam lever pivotally attached to the nut to pivot about a pivot axis perpendicular to a length of the threaded shaft, the cam lever including a cam surface configured to engage the thrust washer, the cam lever being pivotable from an unlatched position to a latched position such that engagement of the cam surface with the thrust washer during pivotal motion of the cam lever biases the thrust washer toward the enlarged head to thereby latch the mounting flange of the concave grate to the support flange of the support frame.

2. The agricultural harvester machine of claim 1, wherein:
each of the concave grates is arcuate in shape including the mounting flange on one circumferential end and including a mounting protuberance on another circumferential end.

3. The agricultural harvester machine of claim 2, wherein:
the mounting flange of each of the concave grates extends radially outward relative to the arcuate shape of the concave grate.

4. The agricultural harvester machine of claim 3, wherein:
the one or more latch assemblies connecting each of the concave grates to the support frame includes two latch assemblies connecting each of the concave grates to the support frame, the two latch assemblies being spaced apart longitudinally relative to the arcuate shape of the concave grate.

5. The agricultural harvester machine of claim 1, wherein:
each of the support flange apertures and the mounting flange aperture is keyhole shaped including a circular end portion and a radial slot portion, the circular end portion having a diameter larger than a maximum width of the enlarged head so that the enlarged head may fit through the circular end portion, the radial slot portion having a width greater than a shaft diameter of the threaded shaft and less than the maximum width of the enlarged head.

6. The agricultural harvester machine of claim 5, wherein:
the width of the radial slot portion is greater than a minimum cross-section of the non-circular shoulder, but is small enough that the non-circular shoulder may be held within the slot to prevent rotation of the carriage bolt.

7. The agricultural harvester machine of claim 5, wherein:
the non-circular shoulder is square in cross-section normal to the length of the threaded shaft so that a position of the carriage bolt within the aligned apertures may be adjusted by increments of 90 degrees.

8. The agricultural harvester machine of claim 1, wherein:
the one or more latch assemblies connecting each of the concave grates to the support frame includes at least two latch assemblies connecting each of the concave grates to the support frame.

9. The agricultural harvester machine of claim 1, wherein:
the nut is a T-nut including a stem having a threaded interior bore for threadedly engaging the threaded shaft; and
the washer has an inner passage within which the stem can be at least partially received.

10. A method of mounting a concave grate on a support frame of a thresher housing of an agricultural harvester machine, comprising:
engaging the concave grate with the support frame;
aligning a mounting flange aperture of the concave grate with a support frame aperture of the support frame;
providing a carriage bolt and cam lever assembly including a carriage bolt, a thrust washer received about the carriage bolt, a nut threadedly engaged with the carriage bolt, and a cam lever pivotally mounted on the nut;
inserting an enlarged head of the carriage bolt through the aligned mounting flange aperture and support frame aperture;
moving a shaft of the carriage bolt laterally into a slot of one of the apertures, the slot having a width greater than a diameter of the shaft and smaller than a minimum dimension of the enlarged head perpendicular to a length of the shaft, so that the support frame and the mounting flange are received between the enlarged head and the thrust washer;
engaging a non-circular shoulder of the carriage bolt with the slot with the enlarged head engaging either the support frame or the mounting flange;
adjusting a threaded connection between the nut and the carriage bolt; and
pivoting the cam lever relative to the nut from an unlatched position to a latched position such that engagement of a cam surface with the thrust washer during pivotal motion of the cam lever biases the thrust washer toward the enlarged head to thereby latch the mounting flange of the concave grate to the support frame.

11. The method of claim 10, wherein:
the mounting flange aperture and the support frame aperture are each keyhole shaped including a circular end portion and the slot extending from the circular end portion, and the aligning includes aligning the circular end portions and the slots of the mounting flange aperture and the support frame aperture.

12. The method of claim 10, wherein:
the non-circular shoulder is square in cross-section normal to the length of the shaft and the adjusting includes adjusting the threaded connection by an integral multiple of 90 degrees.

13. The method of claim 10, wherein:
the adjusting includes adjusting the threaded connection between the nut and the carriage bolt with the cam lever in the unlatched position until the cam surface engages the thrust washer with the support frame and the mounting flange snugly received between the enlarged head and the thrust washer.

14. The method of claim 13, wherein:
the pivoting of the cam lever relative to the nut from the unlatched position to the latched position tightly sandwiches the support frame and the mounting flange between the enlarged head and the thrust washer.

15. The method of claim 10, wherein:
the pivoting of the cam lever to the latched position results in the cam lever being aligned with a length of the thresher housing.

16. The method of claim 10, wherein the method is performed by hand without the use of any tools.
